(19) United States
(12) Patent Application Publication
(10) Pub. No.: US 2015/0151810 A1
(43) Pub. Date: Jun. 4, 2015

(54) FRONT WHEEL LOCKING MECHANISM OF POWER SCOOTER

(71) Applicant: SHANGHAI LERADO DAILY ARTICLE CO.,LTD, SHANGHAI CITY (CN)

(72) Inventors: CHUAN-I CHEN, TAIBAO CITY (TW); NAI-LUNG LIU, KAOHSIUNG CITY (TW); YU-CHIH LIN, YUNLIN COUNTY (TW)

(21) Appl. No.: 14/560,312

(22) Filed: Dec. 4, 2014

(30) Foreign Application Priority Data
Dec. 4, 2013 (CN) 201320786646.8

(51) Int. Cl. B62K 21/24

(52) U.S. Cl. CPC B62K 21/24

(57) ABSTRACT

A front wheel locking mechanism of power scooter includes a sleeve, a steering mechanism, and a positioning mechanism. The sleeve is mounted at the front end of a frame of power scooter, and the steering mechanism includes a shaft sleeved inside the sleeve and formed with an unround-shaped positioning slot. The positioning mechanism is mounted on the sleeve and includes a pin having an enlarged anchoring head contoured with the unround-shaped positioning slot. The enlarged anchoring head can be pressed into the shaft through the unround-shaped positioning slot only in a first angle, and then keeping the enlarged anchoring head continually anchoring inside the shaft by turning the pin driver away from the first angle. By this locking mechanism, the front wheel set can be easily prevented from freely swiveling around, during a user is taking apart, re-assembling, folding or unfolding the frame of power scooter.

### BACKGROUND OF THE INVENTION

1. Field of the Invention

The present invention relates to a front wheel locking mechanism, especially to a front wheel locking mechanism of a power scooter can lock the front wheel while in departing, re-assembling, folding or unfolding the power scooter.

2. Description of the Related Art

Sometimes, the power scooters just happened need to be departed or folded into a smaller or compact size for storage or putting into a small car for transportation, however, in the process of departing, re-assembling, folding or unfolding the frame of power scooter, the freely rotation of the front wheel may cause a lot of troubles and shall endanger the user's hand and fingers.

### SUMMARY OF THE INVENTION

For solving the aforementioned trouble, the present invention provides a front wheel locking mechanism of power scooter, which may include a sleeve, a steering mechanism, and a positioning mechanism.

The sleeve is mounted at the front end of a frame of power scooter, and the steering mechanism may include at least a shaft. The shaft has a lower end connected with a front wheel set and has a length sleeved in the sleeve and formed with a positioning slot within the length.

The positioning mechanism is mounted on the sleeve and includes a pin and a pin driver. The pin is formed with an enlarged anchoring head and a pin body. The enlarged anchoring head is in a shape contoured with the positioning slot, and the pin body is extending from one side of the enlarged anchoring head in a length. The pin driver is accessible from the outside of the sleeve so as to control and move the pin by pushing and turning. The pin driver may be embodied in a form of knob or handle, or any of that can be hold by user's hand to push and turn.

The pin driver has one end connected with the pin body and can move the enlarged anchoring head to pass through the unround-shaped positioning slot only in a first angle, and then keeping the enlarged anchoring head continually anchoring inside the shaft by turning the pin driver away from the first angle.

By the front wheel locking mechanism of the present invention, the front wheel set can be prevented from freely swiveling around, during a user is taking apart, re-assembling, folding or unfolding the frame of power scooter.

### BRIEF DESCRIPTION OF THE DRAWINGS

The accompanying drawings, which are included to provide a further understanding of the invention are incorporated in and constitute a part of this specification, illustrate embodiments of the invention and together with the description serve to explain the principles of the invention. In the drawings:

FIG. 1 is a side view of a power scooter with the front wheel locking mechanism according to the present invention.

FIG. 2 is an exploded view of an embodiment of the front wheel locking mechanism.

FIG. 3 is a schematic view illustrating the operation of turning the pin driver.

FIG. 4 is a schematic cross-sectional view illustrating the operation of pressing the pin driver.

FIG. 5 is a schematic cross-sectional view illustrating the operation of releasing the pin driver while the pin driver has been returned to the first direction.

### DETAILED DESCRIPTION OF THE PREFERRED EMBODIMENTS

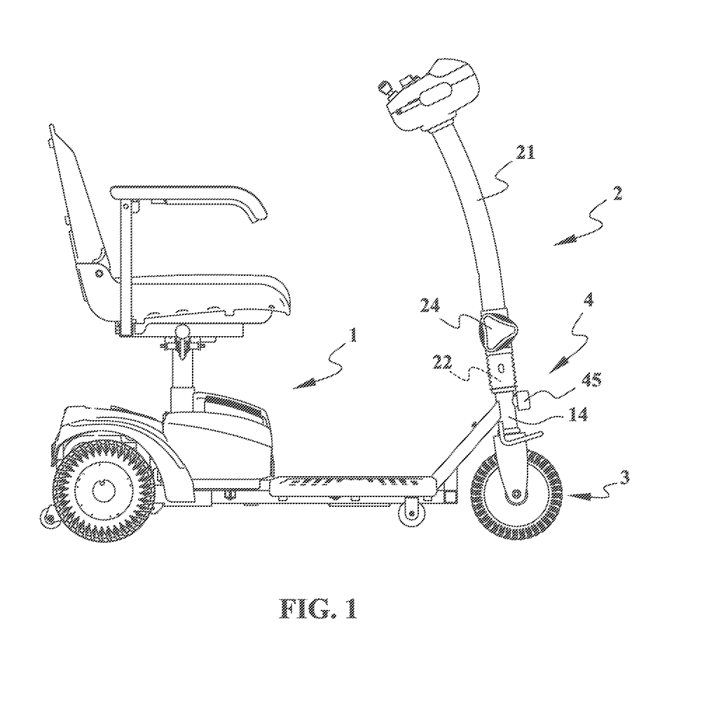

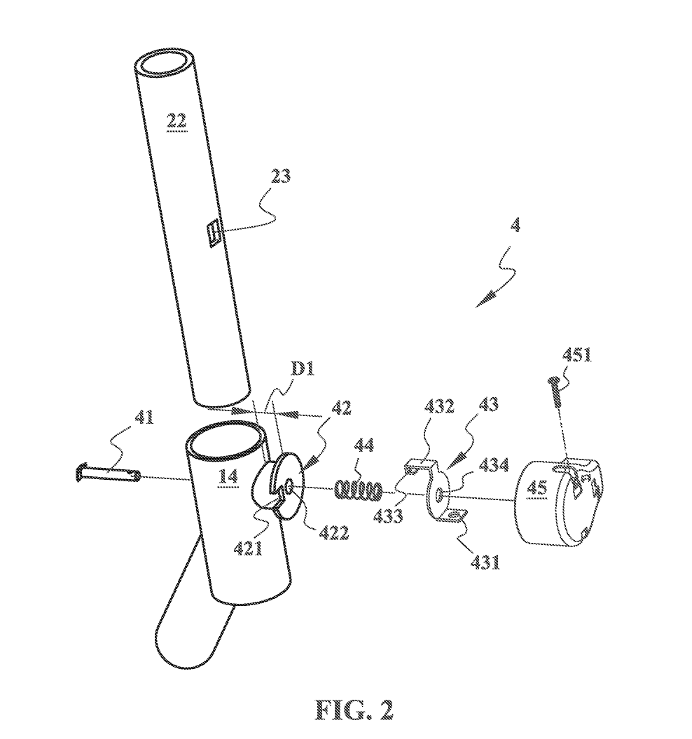

Referring to FIGS. 1 and 2, a front wheel locking mechanism of power scooter according to the present invention, may include a sleeve 14, a steering mechanism 2, and a positioning mechanism 4.

The steering mechanism 2 may include an upper steering part 21 and a lockable joint 24. The lockable joint 24 is connected between the upper steering part 21 and the shaft 22 so as to adjust the height of the steering handles and control panel of the power scooter meet the needs of users of different tall.

The sleeve 14 is mounted at the front end of a frame of power scooter 1, and the steering mechanism 2 includes at least a shaft 22. The shaft 22 has a lower end connected with a front wheel set 3, and has a length sleeved in the sleeve 14 and formed with a positioning slot 23 within the length.

The positioning mechanism 4 is mounted on the sleeve 14 and includes a pin 41 and a pin driver 45. The pin 41 is formed with an enlarged anchoring head in a shape contoured with the positioning slot 23, and the pin body is extending from one side of the enlarged anchoring head in a length. The pin driver 45 is accessible from the outside of the sleeve 14 by hand so as to control and move the pin 41 by pushing and turning. The pin driver 45 may be embodied in a form of knob or handle, or any of that can be hold by user's hand to push and turn.

The pin driver 45 has one end connected with the pin body and can move the enlarged anchoring head to pass through the positioning slot 23 only in a first angle, and then keeping the enlarged anchoring head continually anchoring inside the shaft 22 by turning the pin driver 45 away from the first angle.

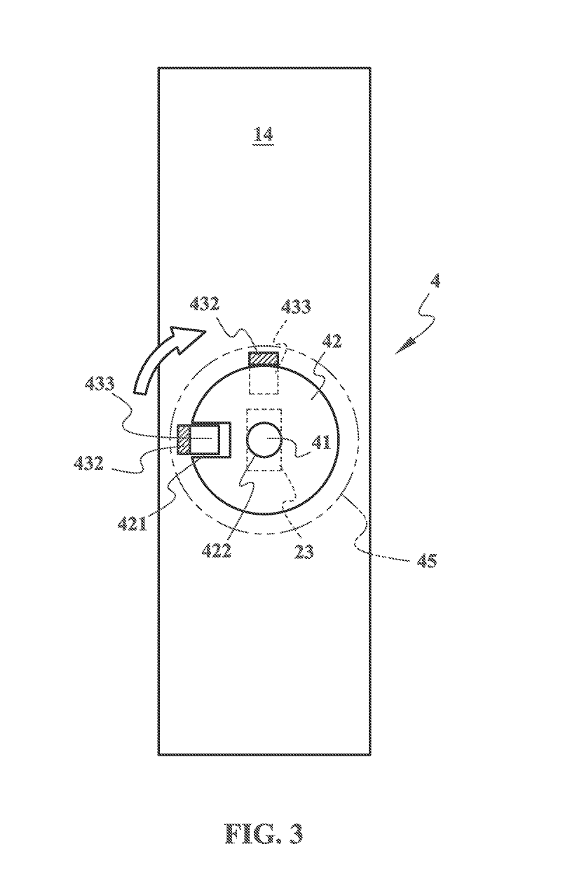

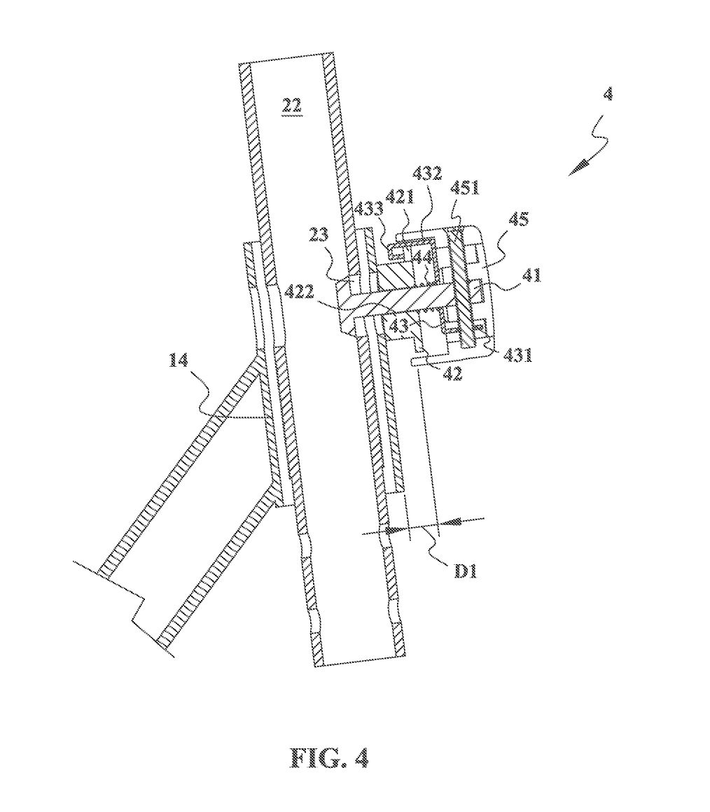

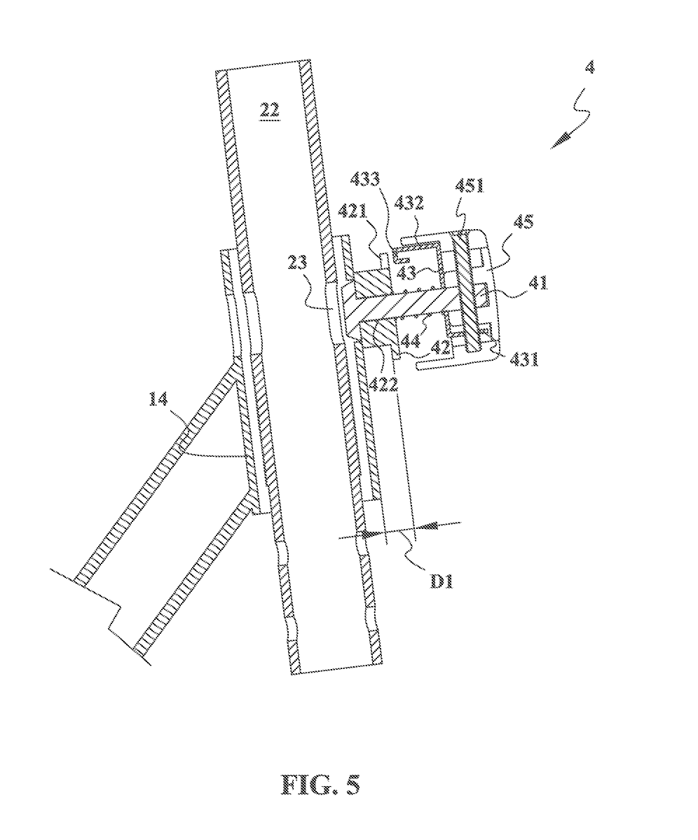

As best shown in FIGS. 2 to 5, the sleeve 14 has a side-extension pin cabin with an end plate 42 for retaining and permitting the pin 41 retractably moving within a distance D1, under the control of pin driver 45.

The end plate 42 in this embodiment is formed with a notch 421 at the first angle and a through hole 422 for permitting the pin body passing through the end plate 42.

As the enlarged anchoring head is larger than the through hole 422, it can only be retractably kept at one side of the end plate 42 and cannot leave the side-extension pin cabin. In an assembling process, the pin body can be inserted from one side of the end plate 42, and then passed through the through hole 422 to connect with the pin driver 45.

Preferably, the pin driver 45 may further include a push-and-rotate spacer 43 for keeping the enlarged anchoring head in the first angle, so as to make the enlarged anchoring head leaving in a distance but always kept to align with the positioning slot 23. The push-and-rotate spacer 43 in this embodiment has an arm 432 extending toward the end plate 42 and an inward extension flip 433 connected at the arm 432. The inward extension flip 433 has a first position engaged stayed within the notch 421 so as to prevent the pin driver 45 from turning away from the first angle, and can be pushed toward the end plate 42 to a second position to left the notch 421, that can permit the pin driver 45 to turn away from the first angle.

Due to the enlarged anchoring head is aligned to match with the positioning slot 23 in the first angle, when the pin driver 45 is pushed at the first angle, the enlarged anchoring head is entering into the inner space of the shaft 22 through the positioning slot 23, and then, when the pin driver 45 is further to turn away from the first angle, the enlarged anchoring head is anchoring inside the shaft 22 continually.

For assembling, the push-and-rotate spacer 43 may be formed with a central hole 434 and a leg 431. The central hole 434 is designed for permitting the pin body of the pin 41 to pass through the push-and-rotate spacer 43, and the leg 431 is used for connecting to the pin driver 45 by a connecting element 451, such as pin(s) or screw(s).

For easy control, a resilient element 44, such as coil-spring, is preferably connected between the end plate 42 and the push-and-rotate spacer 43 for normally keeping the inward extension flip 433 to stay within the notch 421 so as to prevent the pin driver 45 from rotation before being pushed toward the sleeve 14. When the enlarged anchoring head turned back by the pin driver 45, a biasing force of the resilient element 44 shall push the pin driver 4 and therefore retract the enlarged anchoring head to leave the positioning slot 23 and back to the side-extension pin cabin, so as to release the shaft 22 for letting it can be freely swivel again.

The positioning slot 23 and the enlarged anchoring head both can be formed as an unround-shape, such as water-drop-shape, T-shape, J-shape, . . . , however, both of them are preferably to be formed in rectangular or ellipse shapes with at least one long dimension and one short dimension.

By the front wheel locking mechanism of the present invention, the front wheel set 3 can be prevented from freely swiveling around during a user is taking apart, re-assembling, folding or unfolding the frame of power scooter 1.

While particular embodiments of the invention have been described, those skilled in the art will recognize that many modifications are possible that will achieve the same goals by substantially the same system, device or method, and where those systems, devices or methods still fall within the true spirit and scope of the invention disclosed.

What is claimed is:

1. A front wheel locking mechanism of power scooter, including:
a sleeve (14), mounted at a front end of a frame of power scooter (1);
a steering mechanism (2), including at least a shaft (22) which having a lower end connected with a front wheel set (3) and a length sleeved inside the sleeve (14) and formed with a positioning slot (23) within the length, and;
a positioning mechanism (4), mounted on the sleeve (14), including a pin (41) and a pin driver (45), the pin (41) having an enlarged anchoring head contoured with the positioning slot (23) and a pin body extending from one side of the enlarged anchoring head, the pin driver (45) being accessible from outside of the sleeve (14) and having one end connected with the pin body for moving the enlarged anchoring head for passing through the positioning slot (23) in a first angle, and keeping the enlarged anchoring head continually anchoring inside the shaft (22) thereafter by turning the pin driver (45) away from the first angle, thereby preventing the front wheel set (3) from freely swiveling around.

2. The front wheel locking mechanism of claim 1, wherein the sleeve (14) has a side-extension pin cabin with an end plate (42) for retaining and permitting the pin (41) moving within a distance (D1), and the end plate (42) is formed with a notch (421) at the first angle and a through hole (422) permitting the pin body to pass through the end plate (42).

3. The front wheel locking mechanism of claim 2, wherein the enlarged anchoring head is larger than the through hole (422) and retractably kept at one side of the end plate (42); and the pin body is extending from the enlarged anchoring head and passing through the through hole (422) to connect with the pin driver (45).

4. The front wheel locking mechanism of claim 2, wherein the pin driver (45) further includes a push-and-rotate spacer (43) having an arm (432) extending toward the end plate (42) and an inward extension flip (433) connected at the arm (432); the inward extension flip (433) having a first position can normally be kept to engage within the notch (421) so as to prevent the pin driver (45) from turning away the first angle, and the inward extension flip (433) can be pushed to move to a second position to left from the notch (421) thereby permitting the pin driver (45) to turn away from the first angle; when the pin driver (45) is pushed at the first angle, the enlarged anchoring head is entering an inner space of the shaft (22) through the positioning slot (23), and when the pin driver (45) is turned away from the first angle, the enlarged anchoring head is anchoring inside the shaft (22).

5. The front wheel locking mechanism of claim 4, wherein the push-and-rotate spacer (43) is formed with a central hole (434) and a leg (431), and the central hole (434) permits the pin body to pass therethrough, and the leg (431) is connected to the pin driver (45) by a connecting element (451).

6. The front wheel locking mechanism of claim 4 further includes a resilient element (44) connected between the end plate (42) and the push-and-rotate spacer (43), so as to normally keep the inward extension flip (433) stayed within the notch (421) for preventing the pin driver (45) from rotation.

7. The front wheel locking mechanism of claim 1, wherein the positioning slot (23) and the enlarged anchoring head both are formed as an unround-shape.

8. The front wheel locking mechanism of claim 7, wherein the positioning slot (23) and the enlarged anchoring head both are formed as rectangular shape.

9. The front wheel locking mechanism of claim 7, wherein the positioning slot (23) and the enlarged anchoring head both are formed as ellipse shape.

10. The front wheel locking mechanism of claim 1, wherein the pin driver (45) is a knob.

11. The front wheel locking mechanism of claim 1, wherein the pin driver (45) is a handle.

12. The front wheel locking mechanism of claim 1, wherein the steering mechanism (2) includes an upper steering part (21) and a lockable joint (24), and the lockable joint (24) is connected between the upper steering part (21) and the shaft (22).
